(19) United States
(12) Patent Application Publication
(10) Pub. No.: US 2026/0002823 A1
(43) Pub. Date: Jan. 1, 2026

(54) Method and Control Unit For Monitoring The Temperature Of An Electronic Device

(71) Applicant: Schaeffler Technologies AG & Co. KG, Herzogenaurach (DE)

(72) Inventors: Markus Stutika, Regensburg (DE); Jorge Felix Silva Gracia, Regensburg (DE); Fabian Klein, Berlin (DE); Alex Schmidt, Nürnberg (DE)

(73) Assignee: Schaeffler Technologies AG & Co. KG, Herzogenaurach (DE)

(21) Appl. No.: 19/315,765

(22) Filed: Sep. 1, 2025

Related U.S. Application Data
(63) Continuation of application No. PCT/EP2023/085743, filed on Dec. 14, 2023.

(30) Foreign Application Priority Data
Mar. 1, 2023 (DE) 10 2023 201 875.6

(51) Int. Cl. G01K 15/00; G01K 7/42

(52) U.S. Cl. CPC G01K 15/005; G01K 7/427

(57) ABSTRACT

A method for monitoring the temperature of an electronic device is provided. The method includes specifying a position for temperature monitoring in a region of the electronic device and determining a parameter value of a parameter that is associated with an actual temperature at the position. The method also includes calculating a temperature at the position based on the parameter value using a calibrated model, where the calibrated model is implemented in a control unit and calibrated in such a way that the sum of the actual temperature at the position and a specified tolerance threshold is less than or equal to the calculated temperature. A corresponding control unit is also provided.

### CROSS-REFERENCE TO RELATED APPLICATIONS

This application claims the benefit of PCT Application PCT/EP2023/085743, filed Dec. 14, 2023, which claims priority to German Application DE 10 2023 201 875.6, filed Mar. 1, 2023. The disclosures of the above applications are incorporated herein by reference.

### TECHNICAL FIELD

The disclosure relates to a method for monitoring the temperature of an electronic device and a corresponding control unit for carrying out the method.

### BACKGROUND

The overheating of electronic components or products can cause serious damage to the components themselves or to products connected thereto. In the worst case, overheating can lead to a fire and represents a critical safety risk. For this reason, the functional safety requirements in this field are very high, particularly for products that operate with high power or currents and thus potentially generate a lot of heat, such as inverters, battery management systems or electric vehicle chargers.

Systems or products to be monitored are typically equipped with temperature sensors at critical locations. However, this requires a previous complex determination of the respective positions for the sensors in the design phase, where these positions can no longer be changed after the sensors have been installed. The use of sensors is also associated with considerable costs. Furthermore, sensors often cannot even be used at certain positions due to their spatial dimensions alone, so that not all the required positions can be monitored.

### SUMMARY

The disclosure provides an efficient method for monitoring the temperature of an electronic device, which requires only a small number of temperature sensors or even no temperature sensors at all.

One aspect of the disclosure provides a method for monitoring the temperature of an electronic device. The method includes: (i) specifying a position for temperature monitoring in a region of the electronic device; (ii) determining a parameter value of a parameter that is associated with an actual temperature at the position; and (iii) calculating a temperature at the position based on the parameter value using a calibrated model, in such a way that the sum of the actual temperature at the position and a specified tolerance threshold is less than or equal to the calculated temperature. The method can be computer-implemented.

Another aspect of the disclosure provides a control unit in which the calibrated model is implemented and which is configured for carrying out the previously described method. The control unit can have a modelling unit containing the calibrated model.

In the context of the present disclosure, the term “electronic device” can, for example, mean an electronic part or an electronic component of a system, such as a motor vehicle. The motor vehicle may include the electronic device and the control unit. The electronic device can be configured to be operated with high power and/or high currents. The operation of the electronic component can be associated with high heat generation. The electronic device can, for example, be or have a contactor, an inverter, a battery management system, a fuse, e.g. a pyrofuse, or an electric vehicle charger. The electronic device may include one or more power components, for example one or more contactors, one or more inverters and/or one or more fuses. The electronic device can have a geometric arrangement of one or more power components, such as on a printed circuit board and/or in a housing. The electronic device may be a control device.

In the context of the present disclosure, the expression “in a region of the electronic device” may refer to at least one of a position inside the electronic device, a position on the surface of the electronic device, and a position in the surroundings of the electronic device. The surroundings can, for example, include a distance smaller than 50 cm, such as less than 10 cm, for example less than 1 cm from the electronic device.

In the context of the present disclosure, a “position for temperature monitoring” is, for example, a position which has particular relevance for meeting safety requirement levels, for example in comparison with other positions in the region of the electronic device. For example, a particularly large and/or fast heat generation can occur in the position for temperature monitoring, such as in comparison with other positions in the region of the electronic device. More than one position for temperature monitoring can be specified, for example two, three, four, five or more, such as more than ten, for example more than one hundred. The position or positions can be specified with respect to a geometric arrangement of one or more power components. The position or positions can be specified with respect to a circuit board or printed circuit board on which at least one power component is arranged. The one or more positions can be specified with respect to a housing, in and/or on which at least one power component is arranged. The one or more locations can be one or more hotspots, such as thermal hotspots. The position or positions can be inaccessible for direct measurement to be carried out.

In the context of the present disclosure, the expression “determining” may be or may include a measurement of the parameter value using a corresponding measuring device, for example, a sensor. It can also include measuring a value associated with the parameter value. Determining the parameter value can also be or include modelling the parameter value. Determining the parameter value can also be or include looking up the parameter value in a table.

In the context of the present disclosure, the term “parameter” may refer to a characteristic of the electronic device. Appropriate parameter values of a plurality of parameters can be determined, for example, of two, three, four, five or more than five parameters, such as more than ten parameters. The one or more parameters can be a current, a voltage, an internal resistance, a downtime or an ambient temperature or can be representative of the specified characteristics. The one or more parameters can relate to characteristics that are not device temperatures. Alternatively, the one or more parameters may include one or more device temperatures, such as a device temperature at the position of a temperature sensor. The one or more device temperatures can relate to positions in the region of the electronic device that are different from the specified positions. The one or more parameters can be input variables and/or model parameters for the calibrated model.

In the context of the present disclosure, the term “associated with” may mean that the temperature at the position to be monitored correlates with the parameter. In other words, a change in the parameter results in an associated change in temperature and vice versa, such as if further conditions to be specified are met. For example, a current through the electronic device can be associated with the temperature at the position to be monitored, because the current flow causes heat to be generated, which in turn influences the temperature of the electronic component. Similarly, a voltage, an internal resistance and/or an ambient temperature can be associated with the temperature at the position to be monitored.

In the context of the present disclosure, a “calibrated model” may mean a model, the results of which, i.e. the calculated temperatures for example, have been adapted or approximated to corresponding actual values, for example, the corresponding actual temperatures, using experimental data and/or simulations. Such calibration may be performed by selecting appropriate values of model parameters.

In the context of the present disclosure, the calculated “temperature” can be a temperature in a specified operating state of the electronic device, such as in a critical operating state. The critical operating state can be defined by a calculated temperature and/or an actual temperature above a specified temperature threshold. Critical operating states can include those at which the actual temperature has a peak or a maximum and/or at which the actual temperature exceeds 80° C., such as 100° C., for example 120° C. The calculated temperature can be associated with an operating state for which the calibrated model has been calibrated.

In the context of the present disclosure, the term “tolerance threshold” may mean a specified safety margin. The tolerance threshold can define a minimum margin between the actual and calculated temperature. This margin can be set in such a way that it is always observed during operation, such as during normal, fault-free operation of the device. The tolerance threshold can also be set in such a way that it is observed in certain critical operating states and otherwise does not necessarily have to be adhered to. The tolerance threshold may be positive, but can also be negative or zero. The tolerance threshold can also be variably defined, such as depending on a respective operating state of the electronic device. The wording that “the sum of the actual temperature at the position and a specified tolerance threshold is less than or equal to the calculated temperature”, can be understood, in addition to the literal meaning, to mean “the temperature calculated using the calibrated model is at least one specified tolerance threshold greater than a temperature determined using a temperature distribution model and/or using thermal tests of a real exemplar of the electronic device”, in particular if the determined temperature and the calculated temperature refer to the same operating state.

In the context of the present disclosure, the term “control unit” may mean a device which is configured for controlling operations or processes. The control unit can have a processor in which computing operations are executed and control signals are generated. The control unit can have a modelling unit containing the calibrated model.

With the described method for temperature monitoring and the corresponding control unit, it can be possible to make one or more temperature sensors superfluous in comparison with purely sensor-based temperature monitoring, where suitable temperature monitoring is still ensured. For example, temperature modelling can be possible in which not every power component of an electronic device is monitored by a physical temperature sensor attached to the respective power component. Accordingly, expensive temperature measurements can be replaced by other measurement signals that are already available, for example voltage or current measurements. Furthermore, a temperature can be modelled at positions which are not accessible for direct measurement, for example because there is not enough space for a temperature sensor. Temperature signals can be generated with little effort at a large number of desired positions in the region of the electronic device.

Temperature modelling can therefore help to ensure that certain safety requirements for the operation of the electronic device, which can be prescribed by law, are met. Observing the tolerance threshold or the safety margin can represent an additional safety factor. Such safety requirements can relate to protecting against overheating, fire or explosion.

In some implementations, the calibrated model is calibrated using a temperature distribution model of the electronic device and/or using thermal tests on a real exemplar of the electronic device. The real exemplar can be thermally analyzed, for example, as part of test stand measurements. Calibration can be performed depending on the operating state of the electronic device. Calibration of the calibrated model for a given operating state can require that the temperature distribution model models that operating state and/or that the real exemplar assumes that operating state.

The calibrated model can be implemented on a control unit, such as a modelling unit of the control unit. Thus, there can be two models, a comparatively complex and computationally intensive temperature distribution model of the electronic device, with which a simpler model, to be used as the calibrated model, is calibrated. The temperature distribution model can be, for example, a 3D model of the electronic device or a part of the electronic device. It can be implemented on an external computer, which has a higher computing power than the control unit. The simpler model can require less computing power than the temperature distribution model, allowing for faster calculation of corresponding temperature values, in particular real-time calculation. Calibration of the calibrated model can ensure the required accuracy and/or reliability of the calculated temperature values.

In some implementations, the real exemplar is a worst-case exemplar and/or the temperature distribution model is based on a worst-case scenario. This can ensure that the calculated temperature values are not less than or at least only slightly less than the actual temperature values, even if the actual temperature values come from an unfavourable example of the electronic device with respect to heat generation. In other words, all possible operating states and/or design profiles of the electronic device can be taken into account with respect to complying with the tolerance threshold.

In the context of the present disclosure, a “worst-case exemplar” can be a realization of the electronic device or a part of the electronic device, during the operation of which particularly high temperatures are generated, such as at one or more positions of the electronic device critical for safety, for example at the specified positions. The part of the electronic device may include or consist of one or more power components, such as all power components. Temperatures can be high compared to other average or regular exemplars of the electronic device. The worst-case exemplar can be characterized by one or more properties that are at a limit or boundary of a tolerance range. Such a tolerance range can be specified by a data sheet associated with the electronic device and/or by data sheets associated with one or more power modules. For example, the worst-case exemplar can be a exemplar that is at the end of its specified lifetime and/or has characteristics similar to those expected at the end of the specified lifetime. The worst-case exemplar can be a exemplar whose internal resistance is comparatively high, such as compared to regular or average exemplars.

A “worst-case scenario” can be defined by one or more worst-case exemplars and/or by particularly unfavourable operating conditions.

In some examples, at least one power component of the real exemplar is a worst-case power component, such as, all power components of the real exemplar are worst-case power components. With such a procedure, which is in contrast to the usual professional procedure, it can be easy to comply with the tolerance threshold.

In some implementations, the temperature distribution model is prepared on the basis of a worst-case power component, such as under the assumption that all power components of the electronic device are worst-case power components.

In some examples, the real exemplar is a regular exemplar and/or the temperature distribution model is based on a regular scenario. In the context of the present disclosure, a “regular exemplar” can be a realization of the electronic device, or a part thereof, during the operation of which average temperatures are generated, such as at one or more safety-critical positions of the electronic device. The average can be determined in comparison to all eligible exemplars. A “regular scenario” can be defined by one or more regular exemplars and/or by regular operating conditions.

In some implementations, the calibrated model includes a smaller dimension than the temperature distribution model. For example, the calibrated model can be one-dimensional or the dimension can be between one and two. For example, the calibrated model can be realized within the framework of several interacting nodes, where heat exchange between the nodes is modelled. This reduces computational time for the calibrated model, so that a relatively low computational power is required for the control unit. Real-time modelling can also be possible.

In some examples, the method further includes: (i) defining a safety requirement level for the electronic device, (ii) examining whether the parameter meets the safety requirement level, and (iii) plausibility checking the parameter if the parameter does not meet the safety requirement level.

In the context of the present disclosure, the term “plausibility checking” can in particular mean that further reasons and/or facts are provided to support the accuracy and/or reliability of the calculation or estimation of the parameter. The parameter can be so plausibility checked in such a way that a certain degree of reliability and/or a certain degree of accuracy is ensured, which can be specified by the safety requirement level.

Plausibility checking of the parameter can be performed, for example, by taking into account a dependence of the parameter on an ageing of the electronic device and/or a dependence of the parameter on operating parameters such as an ambient temperature. Worst-case assumptions can also be made. Finally, certain measured values can also be taken into account when performing the plausibility checking, which support the calculation or estimation of the parameter. For example, an internal resistance of the electronic device can be determined as an additional input variable for the calibrated model via an additional voltage measurement. Or an ageing dependency can be defined using corresponding measured values. By plausibility checking the parameter, it is possible to ensure that the parameter meets the safety requirement level.

In some examples, the plausibility checking of the parameter includes at least one of the following steps: a dependence of the parameter on an ageing of the electronic device is taken into account when determining the parameter value; a dependence of the parameter on operating conditions, in particular an ambient temperature, is taken into account when determining the parameter value; worst-case assumptions are made when determining the parameter value; a measured value of at least one characteristic, which is different from the parameter, is taken into account when determining the parameter value.

In some examples, the method further includes defining a safety requirement level, where the tolerance threshold is specified in such a way that the safety requirement level is met. For example, the tolerance threshold can have an influence on at least one of a severity, a probability of occurrence and a controllability of a fault of the electronic device, in such a way that the combination of severity, probability of occurrence and controllability meets the safety requirement level. An appropriate selection of the tolerance threshold can ensure a safety margin between the actual temperature and critical temperature values that characterize faulty operating states.

In some implementations, the tolerance threshold is between 0° C. and 50° C., for example between 5° C. and 50° C., such as between 15° C. and 40° C. The tolerance threshold can assume such values when the electronic device is in an operating state in which the actual temperature at the position is comparatively high and/or a maximum temperature is reached in normal operation. The tolerance threshold can also have negative values, for example greater than −10° C. or greater than −5° C., such as if the actual temperature at the position is comparatively low in a current operating state.

In some examples, the safety requirement level defines requirements for an operation of the electronic device with respect to at least one of a severity of a fault in the operation of the electronic device, a probability of occurrence of the fault and a controllability of the fault.

The “severity” of the fault can be characterized by a risk to the user and/or the surroundings. The “probability of occurrence” (exposure) can be characterized by a frequency and/or duration of the fault or an operating state corresponding to the fault. “Controllability” can be determined by a proportion of those users who have handled a situation corresponding to the fault. In the context of the present disclosure, a “fault” may be a faulty operating state of the electronic device in which a risk to a user and/or their surroundings is possible, for example due to high temperatures, fire risk or explosion risk.

The safety requirement level can be determined, for example, by an Automotive Safety Integrity Level (ASIL), such as ASIL-C or ASIL-D, as defined in the ISO 26262 standard. The level of safety requirement determined by ASIL can be determined by risk analysis of a potential hazard, taking into account the degree of severity, exposure and controllability of the relevant vehicle operating scenario. ASIL-D defines the highest safety requirements for the electronic device, followed by ASIL-C.

In some examples, the tolerance threshold is specified depending on a respective operating state of the electronic device. For example, in critical operating states, in which the actual temperatures are high, the tolerance threshold can be greater than in non-critical operating states, for example during cooling processes. Critical operating states can include those in which the actual temperature has a peak or a maximum and/or in which the actual temperature exceeds 80° C., such as 100° C., such as 120° C. Such an example can be advantageous because unnecessary power reductions, such as power reductions of the electronic device or a system including the electronic device, can thereby be avoided. At the same time, safety requirements levels, which primarily relate to critical operating states, can be met.

In some implementations, a service life and/or a lifetime of the electronic device is taken into account when calculating the temperature using the calibrated model. For example, the parameter can be an internal resistance and a lifetime-dependent change in the internal resistance can be taken into account using an ageing curve. For example, the ageing curve can be determined based on measured values. This allows for a more accurate modelling of the parameter and can, for example, reduce power reductions due to the safety requirement levels to be met. As a worst-case assumption, for example, the internal resistance can be set as a parameter value at the maximum possible lifetime.

In some examples, determining the parameter value includes: (i) determining a parameter range, within which an actual parameter value lies, (ii) determining an unfavourable parameter value from the parameter range, at which the calculated temperature is maximum, and (iii) setting the parameter value on the basis of the unfavourable parameter value. For example, the calculated temperature is maximal compared to calculated temperatures for other parameter values from the parameter range. For example, the parameter value can be set equal to the unfavourable parameter value. Such an example can be advantageous because a worst-case scenario is assumed which can ensure compliance with security standards. If an internal resistance increases over the lifetime of an electronic device, but the lifetime of the electronic device is not known, for example, the internal resistance can be assumed at the end of the lifetime.

In some examples, the parameter has at least one of the following characteristics: a current, a voltage, an internal resistance, a downtime and an ambient temperature. The current may be a current at an input and/or output of a power component of the electronic device. The voltage can may be a voltage between the input and output of a power component of the electronic device. All of these parameters can contribute to heat generation and can therefore be indicative of the temperature at the position to be monitored.

In some implementations, the parameter is determined on the basis of a measured value, where, if the measured value is not available, a specified substitute value is used instead of the measured value for determining the parameter, where, the calculated temperature for the specified substitute value is no greater than for the measured value. For example, a constant maximum value can be assumed as a predefined substitute value, such as a constant maximum current. Alternatively, the specified substitute value can be calculated from other variables, wherein corresponding tolerances are added.

Such an example can also be advantageous as a worst-case scenario is assumed which can ensure compliance with security standards. The example can be advantageous because, for example, even in the event of a failure of corresponding measuring devices or sensors, compliance with safety standards can be ensured.

In some examples, parameter values of a plurality of parameters associated with the temperature at the position are determined, and the temperature at the position is calculated based on the parameter values of the plurality of parameters.

In some examples, the plurality of parameters include a temperature measured using a temperature sensor at a further position in the region of the electronic device, which is different from the position. Such an example can be advantageous in order to determine temperatures at positions that are not accessible for direct measurement, particularly precisely and reliably.

In some examples, the method further includes controlling the electronic device in such a way that the calculated temperature remains below a specified temperature limit value, in particular below 170° C., in particular below 150° C. The specified temperature limit value can be determined by a critical temperature at which the electronic device overheats and/or at which there is a risk of fire or explosion of the electronic device. The control can include at least one of a cooling, a shutdown and a disconnection of the electronic device.

A current and/or future temperature may be calculated at the position for temperature monitoring.

In some examples, there is no temperature sensor in the region of the electronic device.

In some implementations, the parameter is not a temperature.

The electronic device may be at least one of a contactor, a fuse, such as a pyrofuse, an inverter, a battery management system and an electric vehicle (EV) charger.

The details of one or more implementations of the disclosure are set forth in the accompanying drawings and the description below. Other aspects, features, and advantages will be apparent from the description and drawings, and from the claims.

### DESCRIPTION OF DRAWINGS

FIGS. 1, 2 and 3 each show an exemplary control unit for temperature monitoring and corresponding positions to be monitored in the region of an electronic device.

FIG. 4 shows an exemplary method for monitoring the temperature of an electronic device.

FIGS. 5 to 10 compare respective calculated and actual temperatures at positions for monitoring the temperature of various electronic devices.

Identical or similar elements or elements which act in an identical manner are provided with the same reference symbols throughout the figures. In some figures, individual reference symbols can be omitted in order to improve clarity. The figures and the size ratios of the elements illustrated in the figures with respect to one another are not to be considered to be true to scale. Instead, individual elements can be illustrated with an exaggerated size for better illustration and/or for better understanding.

### DETAILED DESCRIPTION

Before exemplary embodiments of the disclosure are described in more detail with reference to the figures, a number of basic considerations shall be described in general, on the basis of which exemplary embodiments have been developed.

In some implementations, the required temperature information for the monitoring function is provided by a model-based approach using various other signals available in the system, such as a current, voltages, internal resistances of components, or an ambient temperature. In order to meet functional safety requirements with this approach, for example in the context of ASIL-C or ASIL-D, the monitoring function is designed with at least one of the following properties.
1. The thermally critical components (hotspots) in the system are identified and mapped in the model with corresponding parameters (e.g. contactors as resistance). The corresponding parameters are assumed to be worst cases (e.g. end of life internal resistance for the contactors, supported by validation). In the case of parameters that change over their lifetime or change abruptly in certain situations, the behavior is mapped. 2. The available input signals and the corresponding ASIL integrity are identified. Only input signals or information that has the required ASIL level can be used for the model. This usually relates to current, voltage or available temperatures. If the ASIL level is insufficient, this input signal is supported accordingly (plausibility check, . . . ). Optionally, suitable measurement signals are fed into the system to generate specific information for the model (e.g. additional voltage measurement to calculate internal resistance as input for the model).
3. The model is calibrated or fitted to the respective worst-case components (e.g. contactors with high internal resistance) and the required design profiles using simulations and measurements. An example of such a fitting approach is shown in FIG. 4. The model always calculates a higher temperature than in reality at the corresponding location (safety margin). This safety margin is the prerequisite for achieving ASIL integrity (see the calculated and actual temperatures as shown in FIGS. 5 to 10).
4. The safety margin between actual and calculated temperature is modelled with respect to availability. The margin must not be too high, as otherwise unnecessary power reductions would occur due to detected overtemperature. All design profiles or operating states must therefore be achieved without restriction. To achieve this, all tolerances and faults in the respective signal chain are added together.
5. An adequate substitute value strategy is defined for a possible failure. In the event that input signals fail, the model always reacts in the direction of too high temperatures. This means that substitute values are defined, such as a constant maximum value for current or the current is calculated from other variables and all tolerances are added together.

By implementing these measures, it is possible to provide the temperature information with the appropriate integrity level.

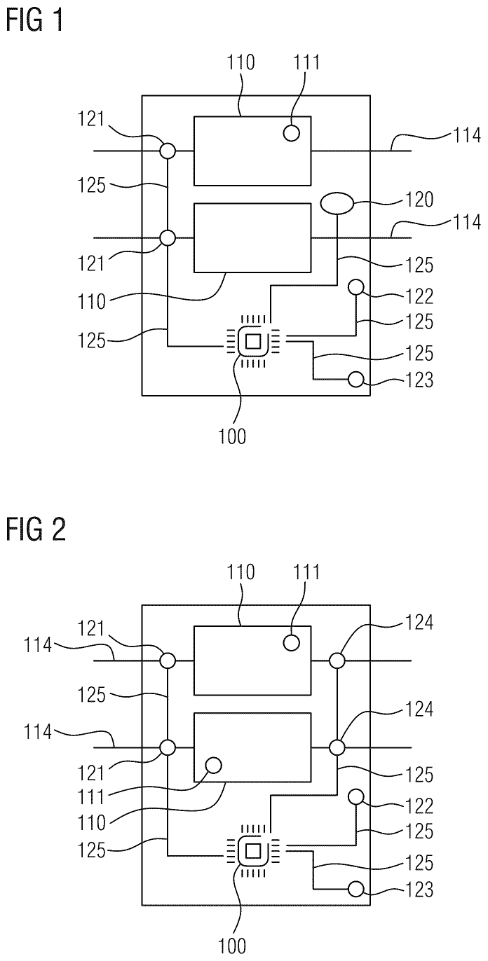

FIGS. 1, 2 and 3 each show a control unit 100, which is configured for carrying out a method for monitoring the temperature of an electronic device 110. The method includes the following steps: (i) specifying a position 111 for temperature monitoring in a region of the electronic device 110, (ii) determining a parameter value of a parameter that is associated with an actual temperature 113 (not shown, see FIGS. 5 to 10) at the position 111, and (iii) modelling a temperature 112 (not shown, see FIGS. 5 to 10) at the position 111 based on the parameter value using a calibrated model, in such a way that the sum of the actual temperature 113 at the position 111 and a specified tolerance threshold is less than or equal to the calculated temperature 112.

The electronic device 110 is a contactor, i.e. an electrically or electromagnetically actuated switch for high electrical powers. For example, the contactor, such as a DC charging contactor, can switch a positive and a negative DC connection (DC+ contactor and DC− contactor). The two elements 110 represent such possibly separately designed switches of two electrical lines 114.

The calibrated model is implemented in the control unit 100, which calculates the temperature 112 at one or more positions 111 to be monitored. Different parameter values are taken into account for the modelling, which are acquired by corresponding measuring devices or sensors 120, 121, 122, 123, 124 and transmitted to the control unit via signal lines 125.

As shown in FIG. 1, there are no temperature sensors in the region of the electronic device 110. The temperature at the position 111 to be monitored is therefore calculated entirely on the basis of other parameters. For example, in the electrical lines 114, a current measuring device 121 is arranged, which transmits measured current values to the control unit 100 as parameter values. Furthermore, an ambient temperature is transmitted to the control unit 110 as a parameter value by a temperature sensor 123 which is not arranged in the region of the electronic device 110. A service life counter 120 transmits a service life and/or a lifetime to the control unit 110 as a parameter value. Finally, a downtime of the electronic device 110 is transmitted by a corresponding downtime counter 122 as an operating parameter.

As shown in FIG. 2, temperature sensors 124 are located in the region of the electronic device 110, which transmit corresponding temperature values to the control unit 100 via signal lines 125. The control unit 100 calculates the temperature at the position to be monitored 111 on the basis of these temperature values and other parameters already known from FIG. 1, namely an ambient temperature, a downtime and current values in electrical lines 121. As shown in FIG. 2, fewer temperature sensors are required in the region of the electronic device compared to a temperature monitoring in which the temperature of the electronic device 110 is monitored using temperature sensors alone. Such an example can also be referred to as a hybrid approach, in contrast to the purely model-based approach of FIG. 1.

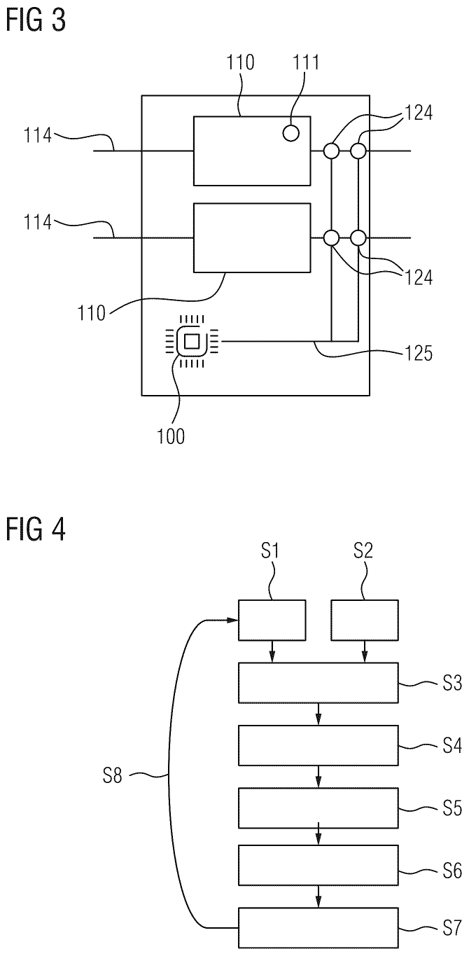

Finally, FIG. 3 shows an example in which temperatures are calculated at positions to be monitored 111 in the region of the electronic device 110, which are not accessible for direct measurement or are difficult to access. The temperatures at these positions 111 are calculated solely on the basis of temperature values measured in the region of the electronic device using sensors 124.

FIG. 4 shows an exemplary method for monitoring the temperature of an electronic device. First, thermal tests with regular and worst-case exemplars are performed (step S1) and 3D simulations with worst-case exemplars, for example worst-case contactors, are performed (step S2). In a subsequent step S3, a hybrid data set is generated by matching and connecting the data of the 3D simulation and thermal tests. In a further step S4, the test and 3D simulation data are interpolated on 1D μC model nodes.

In a subsequent step S5, the nominal resistances are corrected to worst-case resistances for all parts of a hot spot list. In a next step S6, test data on resistances are interpolated at the beginning of lifetime (BOL), at the end of lifetime (EOL) and for worst-case scenarios (WC). In a further step S7, the 1D μC model is fitted to the hybrid data set. Finally, the model can be validated with respect to the data obtained in step 1 and/or step 2 (step 8).

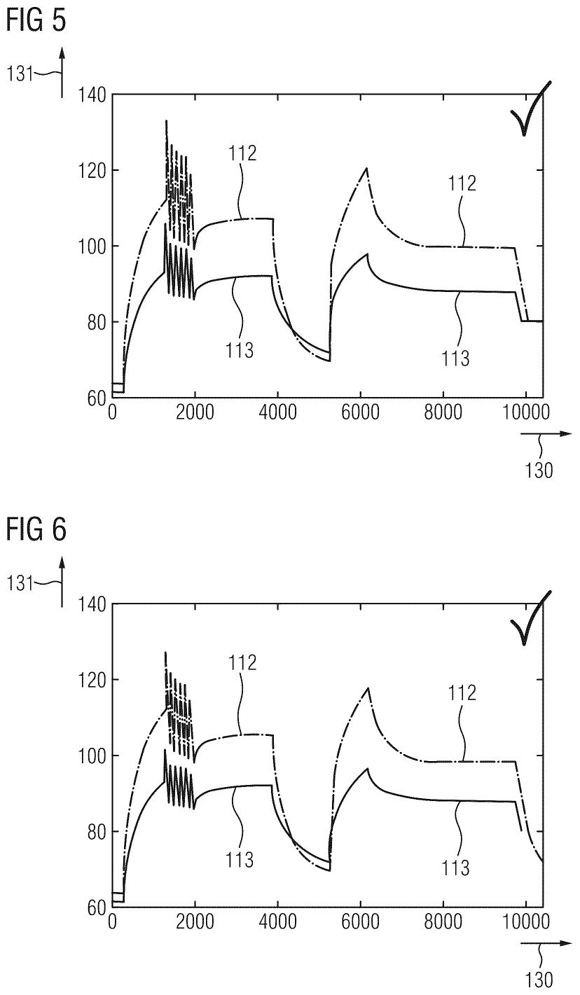

FIGS. 5 to 10 compare calculated temperatures 112 with temperatures measured in a test or actual temperatures 113 at a position for temperature monitoring of various electronic devices. Temperature curves 131 in ° C. over the time 130 in s are shown. The calculated temperature 112 is almost always greater or equal to the actual temperature 113. Exceptions only relate to non-critical phases or operating states where the actual temperature is particularly low (see, for example, the cooling phase at approximately 5000 s in FIGS. 5 and 6). In critical phases, when the actual temperature is particularly high, there is a safety margin or tolerance threshold of approximately 10° C. to 40° C. between the actual and calculated temperature.

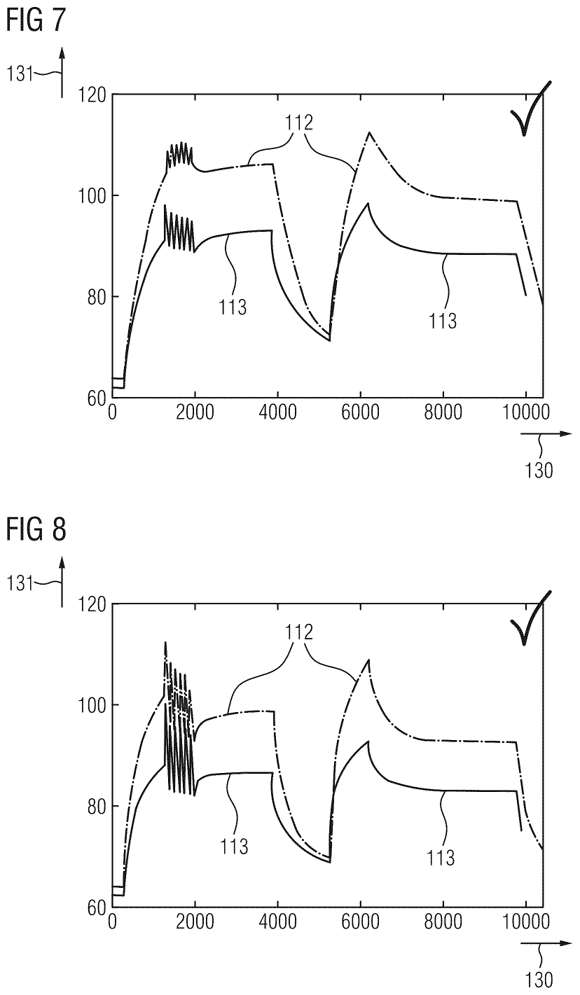

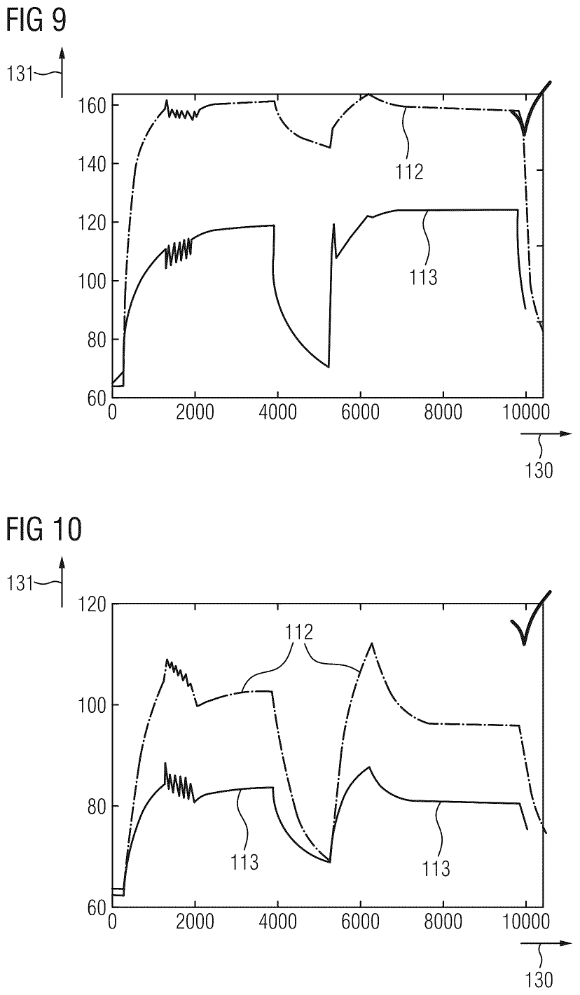

In FIG. 5, the electronic device is a negative contactor, in FIG. 6 a positive contactor, in FIG. 7 a so-called pyrofuse, i.e. a pyrotechnic battery disconnect system, in FIG. 8 a shunt, in FIG. 9 an A1 connector (neg) and in FIG. 10 a B1 connector (neg).

The disclosure is not restricted to the exemplary embodiments by the description on the basis thereof. Instead, the disclosure includes each new feature and each combination of features, which contains, in particular, each combination of features in the exemplary embodiments and patent claims.

What is claimed is:

1. A method for monitoring a temperature of an electronic device, the method comprising:
specifying a position for temperature monitoring in a region of the electronic device;
determining a parameter value of a parameter that is associated with an actual temperature at the position; and
calculating a temperature at the position based on the parameter value using a calibrated model, wherein the calibrated model is implemented in a control unit and calibrated in such a way that a sum of the actual temperature at the position and a specified tolerance threshold is less than or equal to the calculated temperature.

2. The method of claim 1, wherein the calibrated model is calibrated using a temperature distribution model of the electronic device and/or using thermal tests on a real exemplar of the electronic device.

3. The method of claim 2, wherein the real exemplar is a worst-case exemplar and/or wherein the temperature distribution model is based on a worst-case scenario.

4. The method of claim 2, wherein the calibrated model includes a smaller dimension than the temperature distribution model.

5. The method of claim 1, wherein:
parameter values of a plurality of parameters are determined which are associated with the temperature at the position,
the plurality of parameters comprises a temperature measured using a temperature sensor at a further position in the region of the electronic device, which is different from the position, and
the temperature at the position is calculated based on the parameter values of the plurality of parameters.

6. The method of claim 1, further comprising:
defining a safety requirement level for the electronic device;
examining whether the parameter meets the safety requirement level; and
plausibility checking the parameter if the parameter does not meet the safety requirement level.

7. The method of claim 1, wherein the plausibility checking of the parameter comprises at least one of the following steps:
a dependence of the parameter on an ageing of the electronic device is taken into account when determining the parameter value;
a dependence of the parameter on operating conditions, in particular an ambient temperature, is taken into account when determining the parameter value;
worst-case assumptions are made when determining the parameter value;
a measured value of at least one characteristic, which is different from the parameter, is taken into account when determining the parameter value.

8. The method of claim 1, furthermore comprising:
defining a safety requirement level for the electronic device, wherein the tolerance threshold is specified in such a way that the safety requirement level is met.

9. The method of claim 6, wherein the safety requirement level defines requirements for an operation of the electronic device with respect to at least one of the following safety requirement features: a severity of a fault in the operation of the electronic device, a probability of occurrence of the fault and a controllability of the fault.

10. The method of claim 1, wherein the tolerance threshold is specified depending on a respective operating state of the electronic device.

11. The method of claim 1, wherein a service life and/or a lifetime of the electronic device is taken into account when calculating the temperature using the calibrated model.

12. The method of claim 1, wherein the parameter has at least one of the following characteristics: a current, a voltage, an internal resistance, a downtime and an ambient temperature.

13. The method of claim 1, wherein the parameter is determined on the basis of a measured value and wherein, if the measured value is not available, a specified substitute value is used instead of the measured value for determining the parameter, wherein the calculated temperature for the specified substitute value is no greater than for the measured value.

14. The method of claim 1, further comprising:
controlling the electronic device in such a way that the calculated temperature remains below a specified temperature limit value, in particular below 150° C.

15. The method of claim 14, wherein the specific temperature limit value is 150° C.

16. A control unit in which a calibrated model is implemented and which is configured for carrying out a method of claim 1.
